(19) United States
(12) Patent Application Publication
(10) Pub. No.: US 2014/0238182 A1
(43) Pub. Date: Aug. 28, 2014

(54) HANDLE LOCKING AND RELEASE MECHANISM FOR A FOOD PROCESSOR

(71) Applicant: Euro-Pro Operating LLC, Newton, MA (US)

(72) Inventors: David M. Audette, Webster, MA (US); Phillip Bussone, South Hamilton, MA (US); Justin McCarthy, Salem, MA (US); Ajay Patel, Salem, MA (US)

(21) Appl. No.: 13/780,820

(22) Filed: Feb. 28, 2013

(51) Int. Cl. G05G 1/04; G05G 11/00

(52) U.S. Cl. CPC G05G 1/04; G05G 11/00
USPC 74/543

(57) ABSTRACT

Food processing devices with attached handles are disclosed. The handle may be locked to prohibit movement of the handle relative to the food processing device and unlocked to permit movement of the handle relative to the food processing device. The mechanism for unlocking the handle may include a cam-type arrangement. The handle may function as part of a safety system which controls actuation of a motor.

### FIELD

Aspects herein generally relate to a handle locking and release mechanism for an apparatus and methods of using a handle locking and release mechanism. More specifically, aspects disclosed herein relate to a food processing device having a handle and a handle locking and release mechanism, where the handle can be locked to prohibit movement of the handle relative to the food processing device and unlocked to permit movement of the handle relative to the food processing device.

### DISCUSSION OF RELATED ART

Some food processing devices such as juicers and blenders include handles that are permanently fixed to the food processing device. Other food processing devices include moveable handles which can be locked and released. For example, some blender containers include a pivotable handle on a container lid, where the handle is lockable and releasable.

### SUMMARY

According to one embodiment of the invention, an apparatus includes a food processing device with a first engagement member, a handle that is rotatably attached to the food processing device, a release actuator that is rotatably attached to the handle, and a locking member with a second engagement member that cooperates with the first engagement member. The locking member has a locked configuration where the handle is prohibited from moving relative to the food processing device due to interaction between the first and second engagement members. The locking member also has an unlocked configuration where the handle is permitted to move relative to the food processing device. Rotation of the release actuator relative to the handle causes linear translation of the locking member from the locked configuration to the unlocked configuration.

According to another embodiment of the invention, a handle arrangement for a food processing device includes a handle that is rotatably attachable to a food processing device. The food processing device has a first engagement member. The handle arrangement also includes a release actuator that is rotatably attached to the handle and a locking member with a second engagement member that cooperates with the first engagement member. The locking member has a locked configuration where the handle is prohibited from moving relative to the food processing device due to interaction between the first and second engagement members. The locking member also has an unlocked configuration where the handle is permitted to move relative to the food processing device. Rotation of the release actuator relative to the handle causes linear translation of the locking member from the locked configuration to the unlocked configuration.

According to a further embodiment of the invention, a method includes rotating a release actuator relative to a handle, where the release actuator is rotatably attached to the handle, and the handle is rotatably attached to a food processing device. Rotating the release actuator causes linear translation of a locking member from a locked configuration where the handle is prohibited from moving relative to the food processing device to an unlocked configuration where the handle is permitted to move relative to the food processing device.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a perspective view of a food processing device with a rotatably attached handle in accordance with an aspect of the invention;

FIG. 2 is an enlarged perspective view of the handle depicted FIG. 1 with a release actuator and a pivot, where the handle is shown in phantom;

FIG. 3 is another enlarged perspective view of the handle depicted FIG. 1 with a release actuator and a pair of pivots, where the handle is shown in phantom;

FIG. 4A is a front perspective view of the release actuator depicted in FIG. 2;

FIG. 4B is a rear perspective view of the release actuator depicted in FIG. 2;

FIGS. 5A-5B are perspective views of the pivot depicted in FIGS. 2-3;

FIG. 6A is a cross-sectional view of a cam-type mechanism in accordance with an aspect of the invention;

FIG. 6B is a partially cut-away rear perspective view of the handle, with the locking member removed;

FIG. 7A is a schematic depiction of the cam-type mechanism, where the locking member is shown in the locked configuration;

FIG. 7B is a schematic depiction of the cam-type mechanism, where the locking member is shown in the unlocked configuration;

FIG. 8 is an enlarged perspective view of the locking member depicted in FIG. 6A;

FIG. 9A is an overhead view of the cam-type mechanism, with the handle shown in phantom;

FIG. 9B is an overhead view of the cam-type mechanism, with the handle removed;

FIG. 10 is a schematic depiction that illustrates the mechanical advantage of the release actuator;

FIG. 11 is a perspective view of the release actuator that illustrates the mechanical advantage of the release actuator;

FIG. 12A is a schematic depiction of the handle locking and release mechanism, where the handle is shown in an unlocked state;

FIG. 12B is a schematic depiction of the handle locking and release mechanism, where the handle is shown in a locked state and the locking member is in the locked configuration;

FIG. 13 is an underside perspective view of the handle, the handle having pins in accordance with an aspect of the invention;

FIG. 14 is a perspective view of the food processing device with the handle removed, the food processing device having a pair of actuators;

FIG. 15 is an enlarged perspective view of the actuator depicted in FIG. 14, where the actuator cover is shown in phantom;

FIG. 16A is an enlarged perspective view of the actuator with the actuator cover removed, the actuator being in a first position;

FIG. 16B is an enlarged perspective view of the actuator with the actuator cover removed, the actuator being in a second, extended position;

FIG. 17A is an underside perspective view of the food processing device, where the actuator is in a first position; and

FIG. 17B is an underside perspective view of the food processing device, where the actuator is in a second, extended position.

### DETAILED DESCRIPTION

Provided herein are embodiments where a handle can be locked to prohibit movement of the handle relative to the food processing device and unlocked to permit movement of the handle relative to the food processing device.

Applicant has appreciated that in handle locking arrangements where the food processing device has a first engagement member and the handle has a second engagement member which engages with the first engagement member to lock handle movement, translation of the second engagement member may be advantageous as compared to a rotating engagement member. Specifically, in some cases, the total distance that the second engagement member has to travel to clear the first engagement member may be less in a translating disengagement arrangement.

However, in some cases, a user may find a release actuator that operates via rotary motion easier to actuate. For example, where the handle itself is to be pivoted once unlocked, a handle release actuator that pivots in the same direction as the handle may allow the user to unlock and pivot the handle in one natural movement. Such an arrangement may permit a simple, one-handed unlocking and pivoting of the handle. In contrast, requiring the user to first linearly push or pull on a release actuator in a first direction and then pivot the handle in a different direction, may be awkward and difficult for the user, and, in some cases, may require the use of two hands.

According to one aspect, the mechanism for releasing the handle from the locked state may include a cam-type arrangement. With a cam-type arrangement, rotary motion of a release actuator may be transformed into linear motion of a locking member from a locked to an unlocked configuration.

In some cases, the release mechanism may be arranged to provide a mechanical advantage that reduces the amount of force required to unlock the handle.

As used herein, the terms “attached” and “coupled” are not limited to a direct connection, attachment, or coupling, as two components may be connected, attached, or coupled to one another via intermediate components.

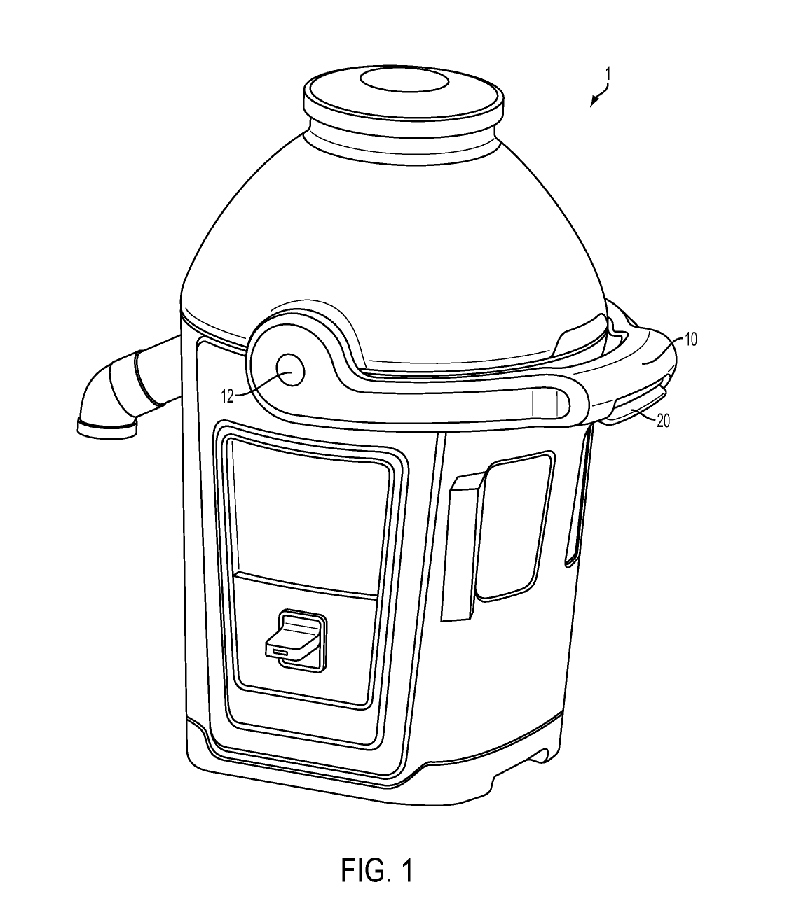

According to one embodiment, as shown in FIG. 1, a food processing apparatus includes a food processing device 1 and a handle 10 that is rotatably attached to the food processing device 1 via a handle pivot 12. The handle 10 can be held in a locked state such that it is not free to pivot or rotate relative to the food processing device 1. The handle 10 includes a release actuator 20 that can be actuated to release the handle from a locked state.

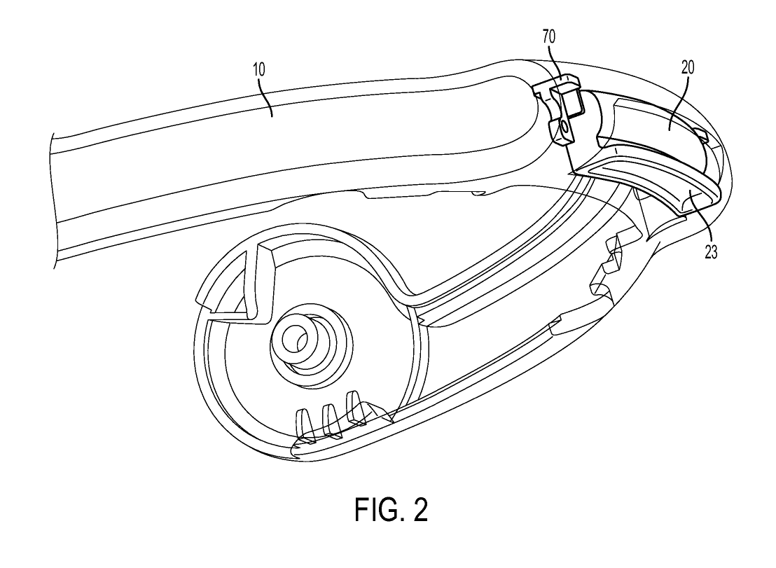

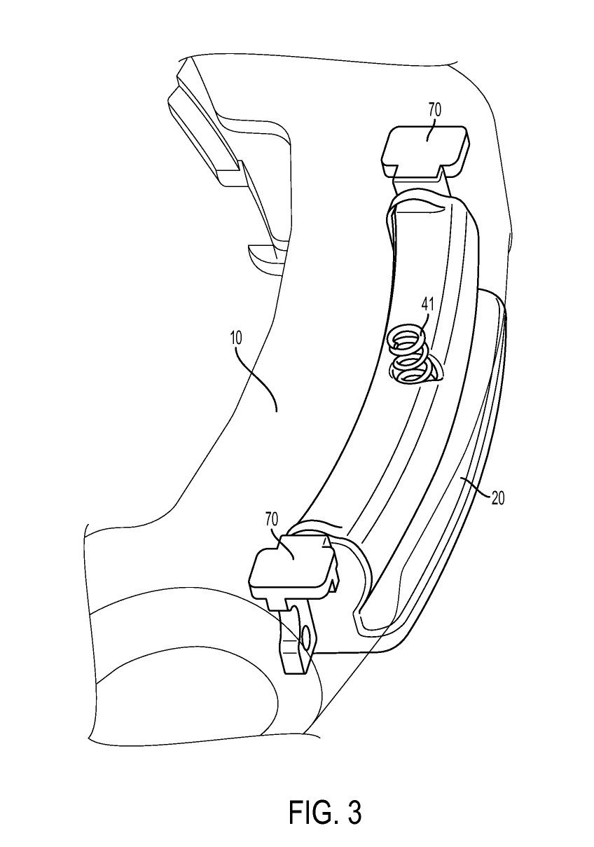

As shown in FIGS. 2-3, where the handle 10 is shown in phantom, the release actuator 20 is rotatably attached to the handle 10 via pivots 70 located at each end of the release actuator 20. The release actuator 20 includes a user-engaging portion 23 which a user contacts to apply a force to rotate the release actuator 20 relative to the handle 10. In some embodiments, the user-engaging portion is a recess that may receive a user's finger, such as a thumb. The user may grasp the handle 10 with her entire hand and, with her thumb on the user-engaging portion 23, rotate the user-engaging portion 23 with the thumb to unlock the handle 10. The user may then rotate the handle 10. Of course, it should be appreciated that various alternatives and/or additions may be used, as this aspect is not so limited. For example, the user-engaging portion may include a texture or surface roughness to facilitate user contact. The user-engaging portion may be a protrusion rather than a recess, or the user-engaging portion may be flat. The user-engaging portion may include indicia such as figures or text that direct the user to rotate the release actuator.

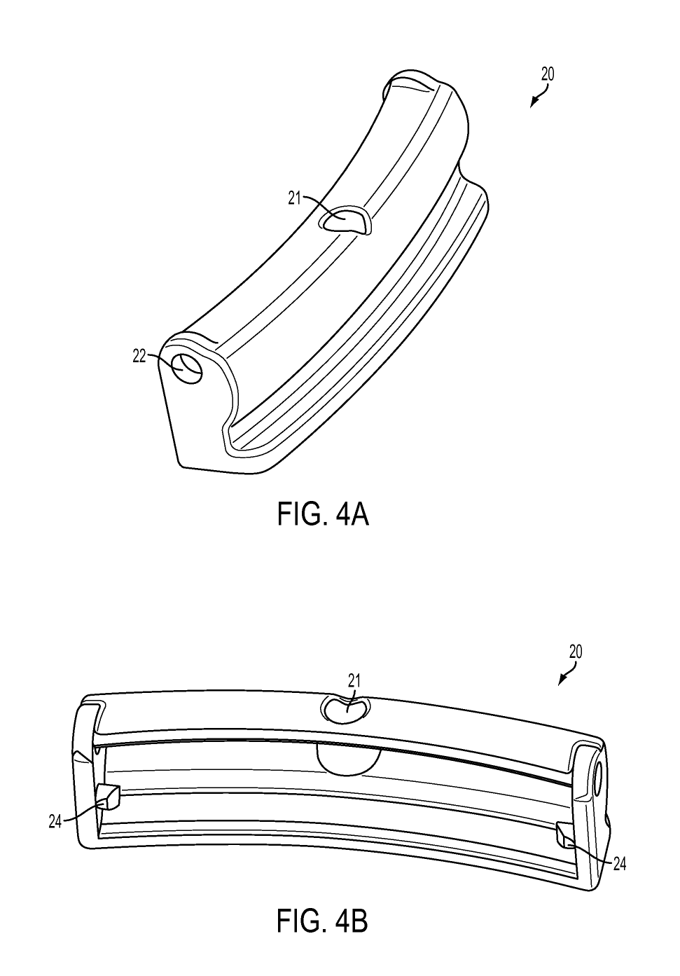

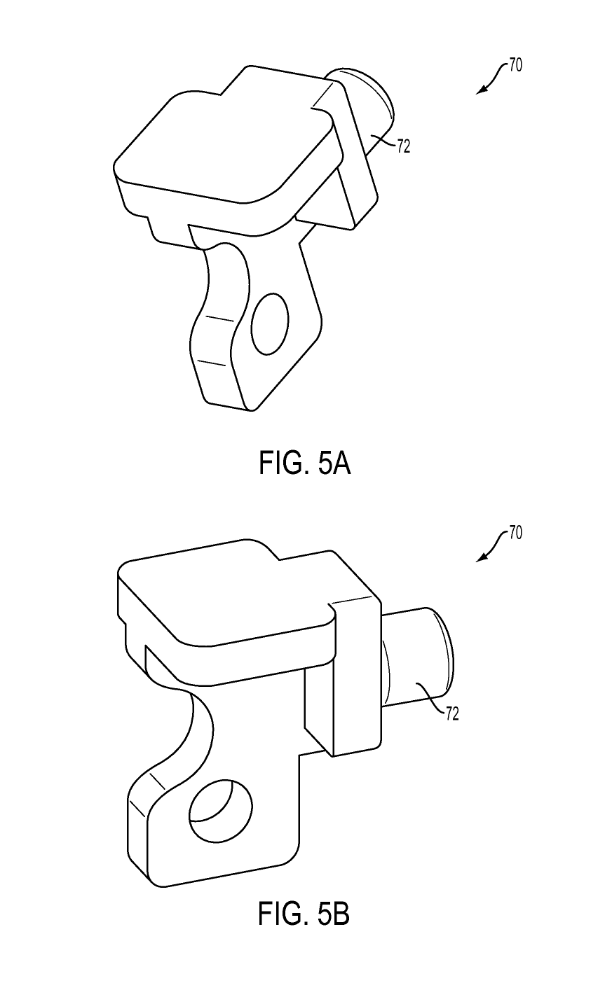

As shown in FIG. 3, a spring 41 biases the release actuator 20 in the clockwise direction. An application of force upon the release actuator 20 to rotate the release actuator 20 in the counterclockwise direction causes the spring 41 to become compressed between the release actuator 20 and the handle 10. The spring thus urges the release actuator 20 back toward the clockwise direction once application of force upon the release actuator 20 has ceased. The spring 41 is seated within an opening 21 of the release actuator, shown in FIGS. 4A-4B.

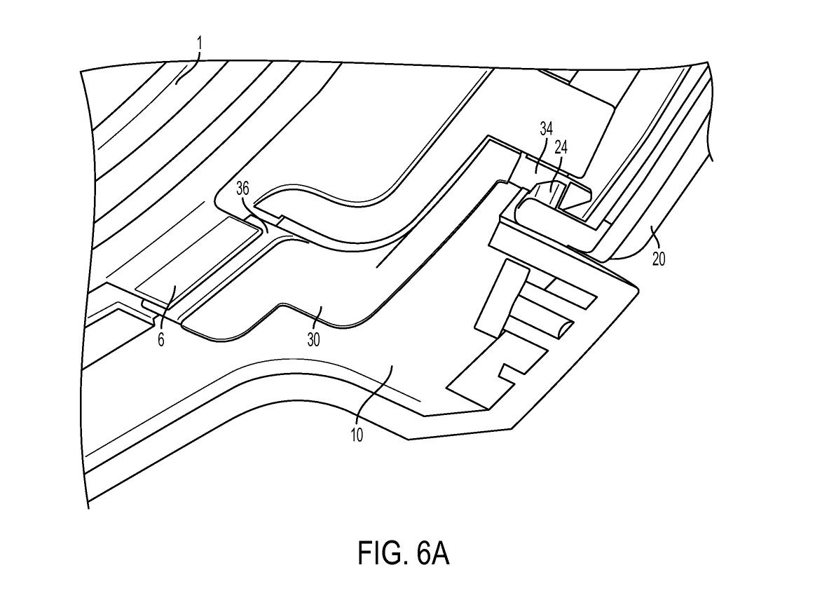

FIGS. 4-5 show the release actuator 20 and the pivots 70 in greater detail. Each opening 22 on either end of the release actuator engages with the pivot surface 72 of a pivot 70. Pivots 70 are fixed to the handle 10. Thus, as the release actuator 20 rotates about the pivot surfaces 72, the release actuator 20 rotates relative to the handle 10.

As shown in FIG. 4B, the release actuator 20 includes two pins 24, which serve as the cams in a cam-type release mechanism, which will now be discussed.

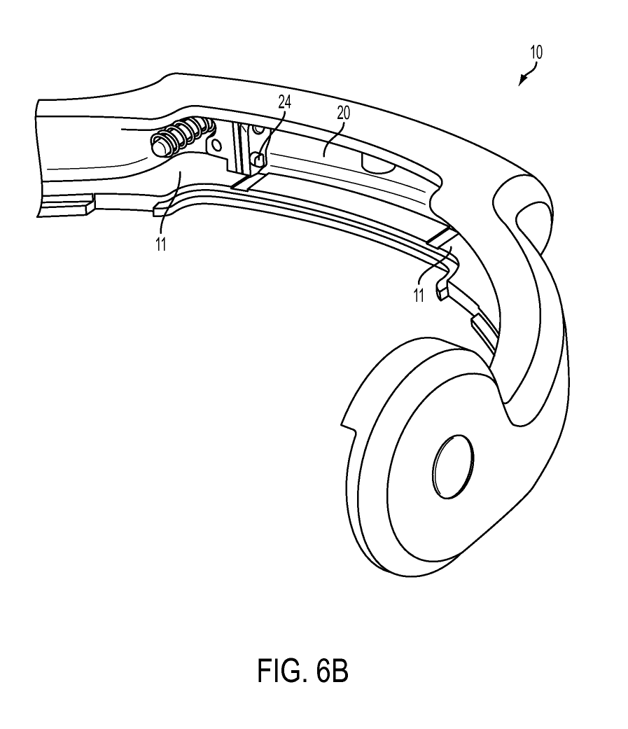

FIG. 6A is a cross-sectional view that shows one embodiment of the cam-type mechanism, which may include the food processing device 1, a locking member 30, handle 10, and a release actuator 20. Handle 10 may be hollow and may hold locking member 30 inside. Locking member 30 may move relative to the handle 10, but locking member 30 may be constrained to move linearly in a horizontal direction toward and away from the food processing device 1. As shown in FIG. 6B, where the locking member 30 is not shown, the inside of handle 10 may include a track 11 that constrains the movement of the locking member 30.

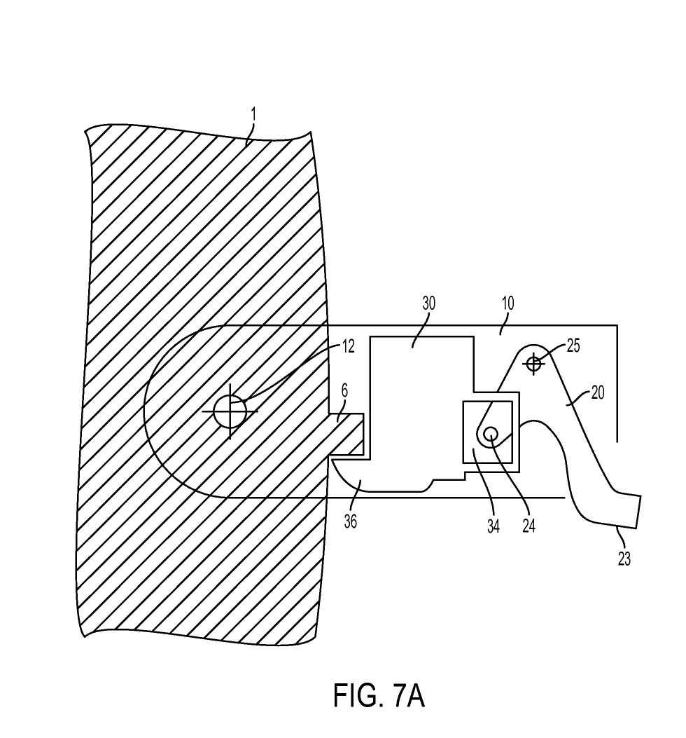

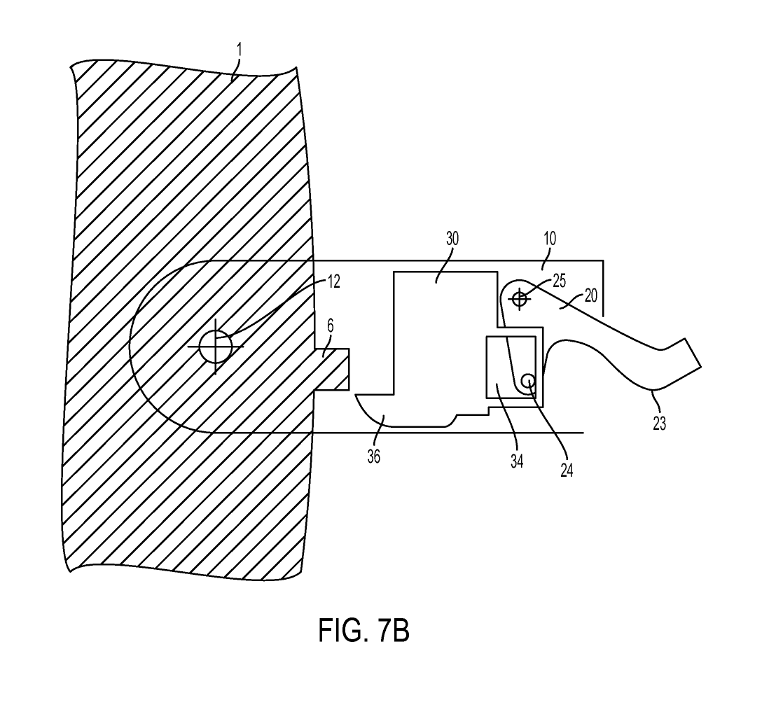

FIGS. 7A-7B schematically depict the cam-type mechanism. FIG. 7A depicts the locking member 30 in a locked configuration and FIG. 7B depicts the locking member 30 in an unlocked configuration. The food processing device 1 may include a first engagement member 6, which, in one embodiment, is a protruding tab. As shown in FIG. 7A, the tab 6 of the food processing device 1 may interact with a second engagement member 36 located on the locking member 30 when the locking member 30 is in the locked configuration. As viewed in FIG. 7A, with the locking member 30 is in the locked configuration, handle 10 is prohibited from rotating counterclockwise about handle pivot 12 due to abutment of the second engagement member 36 of the locking member 30 against the first engagement member 6 of food processing device 1.

As viewed in FIG. 7A, rotation of the user-engaging portion 23 of the release actuator 20 counterclockwise about pivot point 25 causes pin 24 to initially rotate counterclockwise within opening 34 of the locking member 30. As best seen in FIG. 6A, pin 24 is positioned inside opening 34. As viewed in FIG. 7B, further rotation of release actuator 20 causes pin 24 to abut against the inside of opening 34 in a direction away from the device 1 (to the right as viewed in FIG. 7B). Since locking member 30 is constrained to move linearly in a horizontal direction, the abutment of the pin 24 against the inside of opening 34 causes the entire locking member 30 to slide away from the food processing device 1 linearly and horizontally to the right until the second engagement member 36 of the locking member 30 slides past the first engagement member 6 of the device 1. With a second engagement member 36 of the locking member 30 no longer directly beneath the first engagement member 6, the locking member 30 is placed in the unlocked configuration. In some cases, when the locking member 30 is in the unlocked configuration, a small horizontal separation or gap may exist between the first and second engagement members 6, 36. When the locking member 30 is in the unlocked configuration, as shown in FIG. 7B, the first engagement member 6 no longer obstructs movement of the handle 10 and thus the handle 10 is free to rotate upward toward the device 1 about handle pivot 12 (counterclockwise as viewed in FIG. 7). In the cam-type mechanism described in this embodiment, the pin 24 on the release actuator 20 serves as a cam and the opening 34 on the locking member 30 serves as a cam follower. Rotary motion of the release actuator 20 is transformed into linear motion of the locking member 30 due to interaction between the cam 24 and the cam follower 34.

As seen in FIG. 7A, in some embodiments, when locking member 30 is in the locked configuration, pivot point 25 of the release actuator 20 may be positioned vertically above pin 24. As used herein, “vertically above” does not necessarily mean directly above. For example, as shown in FIG. 7A, pivot 25 is vertically above pin 24 but horizontally offset from pin 24 such that pivot 25 is not directly above the pin 24. Vertical distance between the pivot 25 and the cam 24 may permit the pin 24 to start its movement in a horizontal or close-to horizontal direction sooner upon counterclockwise rotation of the release actuator 20. For example, in contrast to the arrangement shown in FIG. 7A, if the vertical distance between the pivot 25 and the pin 24 were reduced to zero but the same horizontal offset as that shown in FIG. 7A were maintained, the pin 24 would initially move vertically downward upon counterclockwise rotation of the release actuator 20. Increasing the vertical distance between the pivot 25 and pin 24 may thus cause the pin 24 to assume an initial trajectory that is closer to horizontal upon counterclockwise rotation of release actuator 20.

Of course, it should be appreciated that various arrangements are possible, as this aspect is not so limited. In some cases, the horizontal offset between the pivot 25 and the pin 24 when the locking member 30 is in the locked configuration may be eliminated such that the pivot 25 is directly above the pin 24. In some cases, the vertical distance between the pivot 25 and the pin 24 when the locking member 30 is in the locked configuration may be decreased or eliminated. In some cases, the pivot 25 may be located vertically below the pin 24.

In embodiments where the overall handle is oriented relative to horizontal in a different orientation than shown in the embodiments herein when locked, the pivot 25 may not necessarily be positioned vertically above pin 24. Yet, the same overall relative orientation of pivot 25, pin 24 and the engagement members may be maintained. Accordingly, a more general description of the arrangement in some embodiments is that the release actuator, the pivot 25 and the pin 24 are not collinear when viewed from the side. In some embodiments, the three components form a right triangle when viewed from the side.

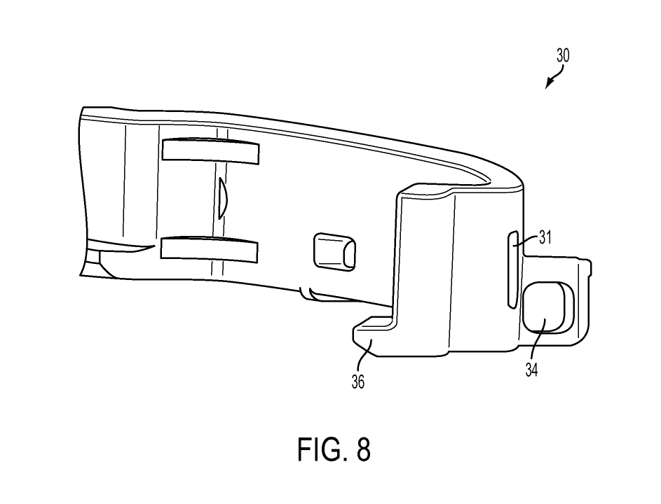

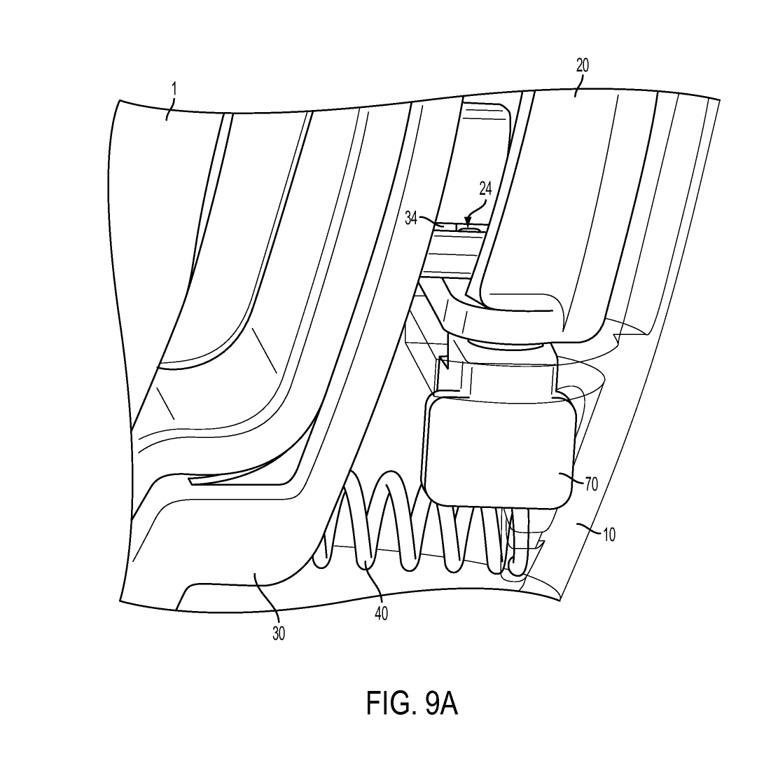

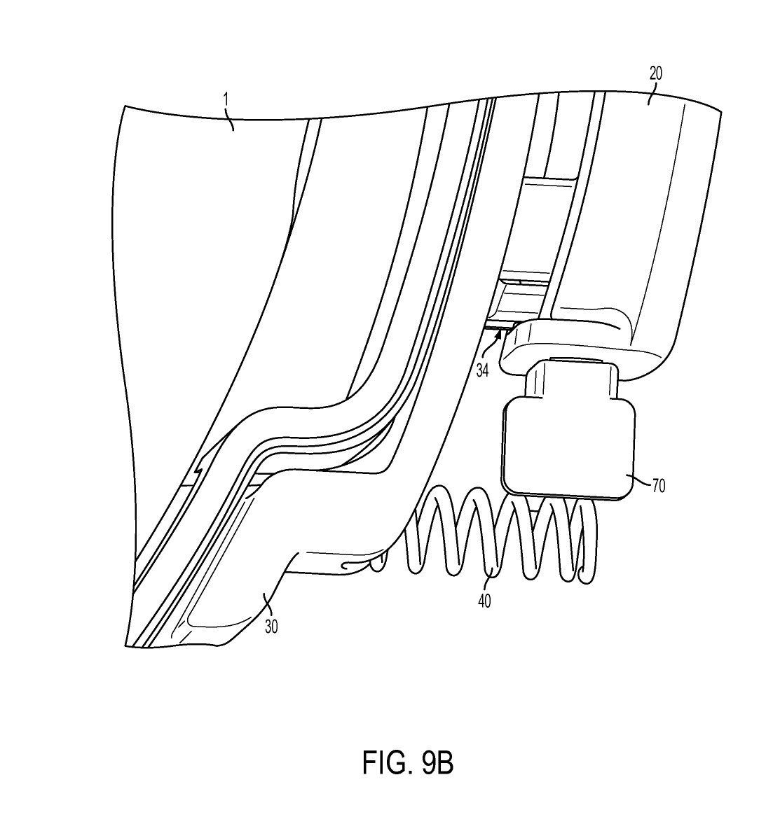

FIG. 8, which shows an enlarged portion of the locking member 30 in isolation, shows the second engagement member 36 and the opening 34. In some embodiments, the locking member 30 also includes an opening 31 that receives a spring, shown in FIGS. 9A-9B.

As shown in FIGS. 9A-9B, a spring 40 is located within handle 10. One end of the spring 40 abuts against locking member 30 while the other end abuts against handle 10. The spring 40 biases the locking member 30 in a direction toward the food processing device 1. Movement of the locking member 30 away from the food processing device 1 causes the spring 40 to compress. Thus, once application of force to the locking member 30 has ceased, the compressed spring 40 releases its stored potential energy to urge locking member 30 back toward the food processing device 1.

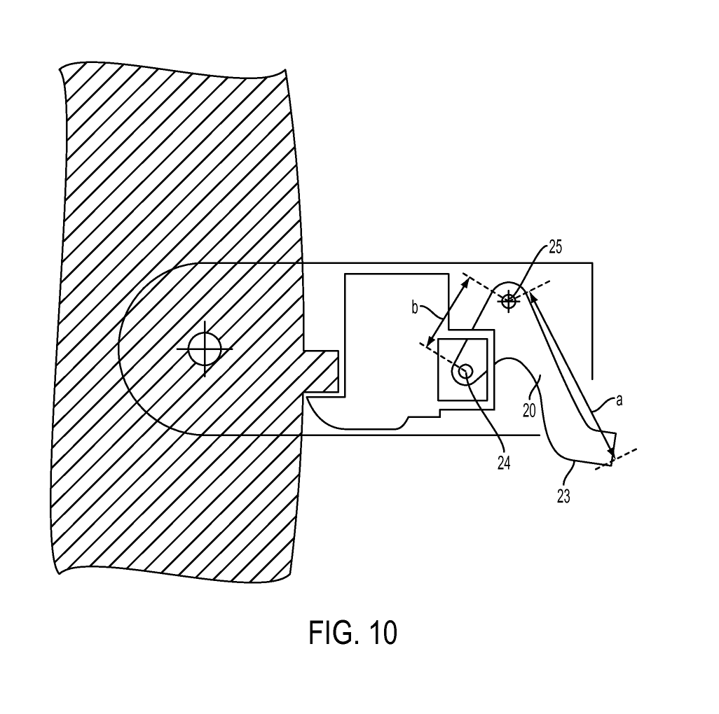

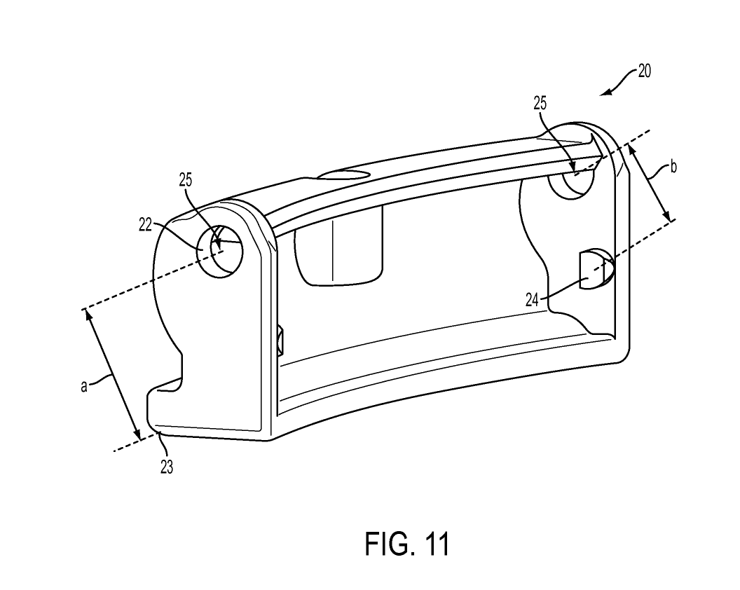

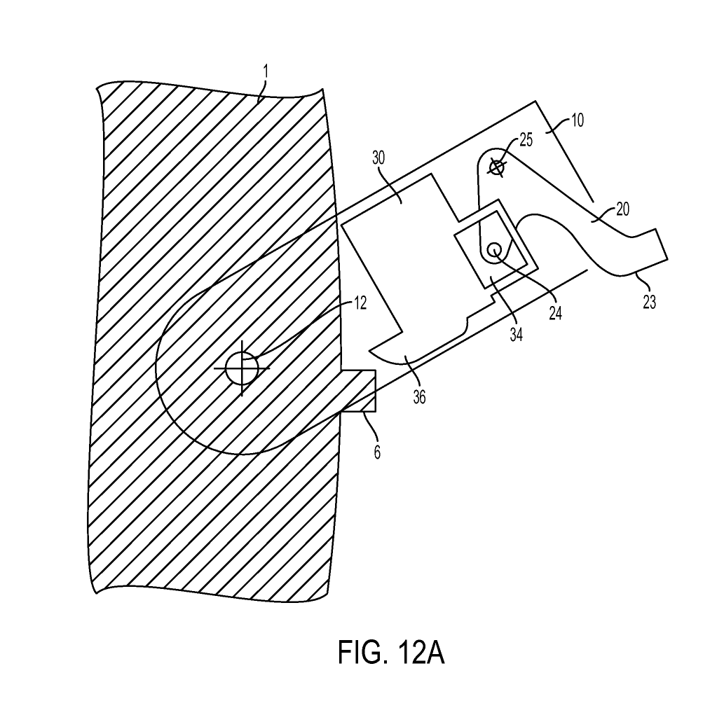

As shown in FIG. 10, the release actuator 20 may act as a lever system, with pivot point 25 as the fulcrum, user-engaging portion 23 as the effort application point, and pin 24 as the load application point. In some embodiments, the pivot point 25, user-engaging portion 23 and pin 24 may be positioned to create a mechanical advantage, where mechanical advantage is defined as the ratio of output force to input force. Mechanical advantage is equal to the ratio of the distance between the fulcrum and the effort application point to the distance between the fulcrum and the load application point. As shown schematically in FIGS. 10 and 11, the distance “a” between the pivot point 25 and the user-engaging portion 23 is greater than the distance “b” between the pivot point 25 and the pin 24. Since the mechanical advantage of the lever is the ratio a:b, the mechanical advantage of the release actuator 20 in this embodiment is greater than 1.

Of course, it should be appreciated that various lengths of “a” and “b” may be used, as this aspect is not so limited. For example, “a” and “b” may have equal lengths, or “b” may be longer than “a.” As such, the mechanical advantage of the release actuator may be equal to or less than 1.

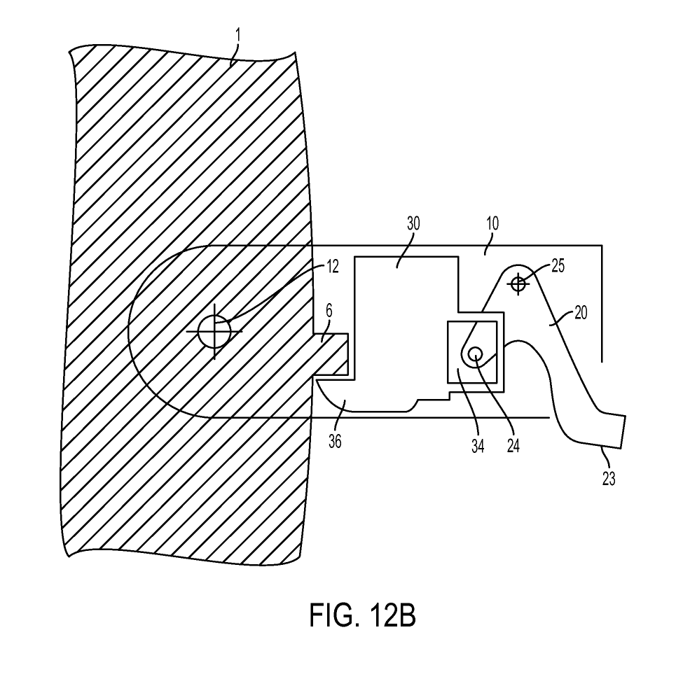

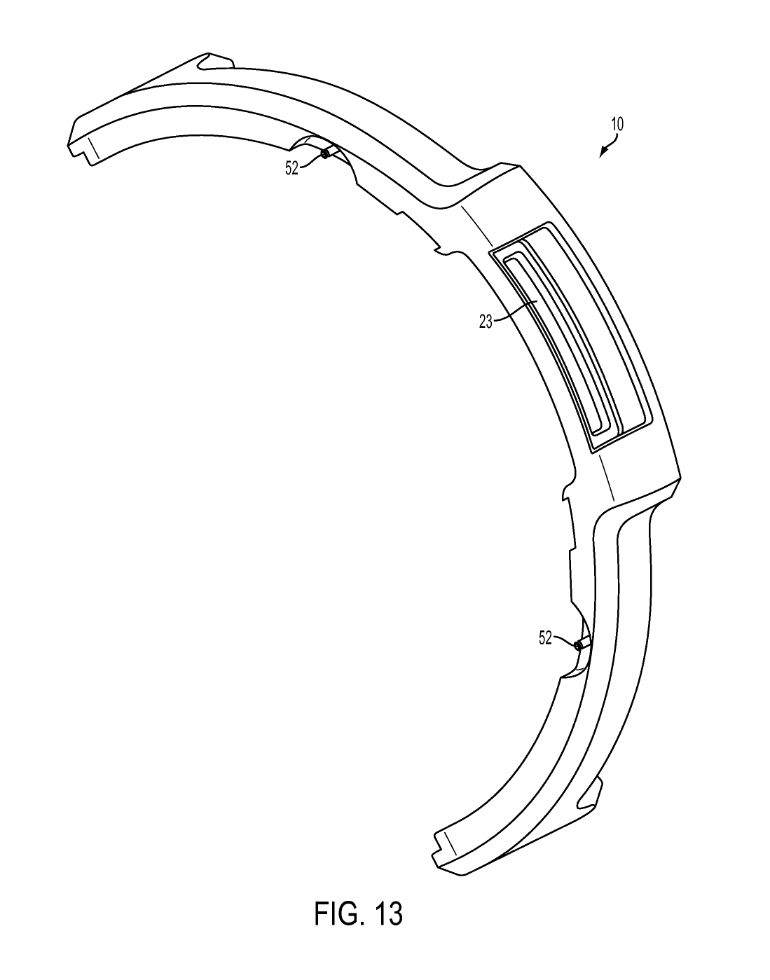

FIGS. 12A-12B schematically depict how the handle can be rotated down from an unlocked state to the locked state. As shown in FIG. 12A, handle 10 is in an unlocked state and locking member 30 is in an unlocked configuration, since both the handle 10 and locking member 30 are free to rotate relative to the food processing device 1. As handle 10 rotates downward about handle pivot 12 in the clockwise direction, the second engagement member 36 of the locking member 30 contacts the first engagement member 6 of the device 1, as shown in FIG. 12A. The rounded bottom edge of the second engagement member 36 slides against the stationary first engagement member 6, causing locking member 30 to slide linearly outward away from the device 1, allowing the second engagement member 36 to slide past the first engagement member 6 until the handle 10 is rotated all the way down into its lowermost position. As shown in FIG. 12B, once the handle 10 is in the lowermost position, because the locking device 30 is biased towards the device 1 by a spring 40 as discussed and shown above, the locking device 30 slides back toward the device 1 into the locked configuration such that the second engagement member 36 is obstructed by the first engagement member 6 of the device 1, thereby placing handle 10 in the locked state. When the locking device 30 is in the locked configuration shown in FIG. 12B, the handle 10 is prohibited from rotating upward toward device 1 about handle pivot 12 in the counterclockwise direction.

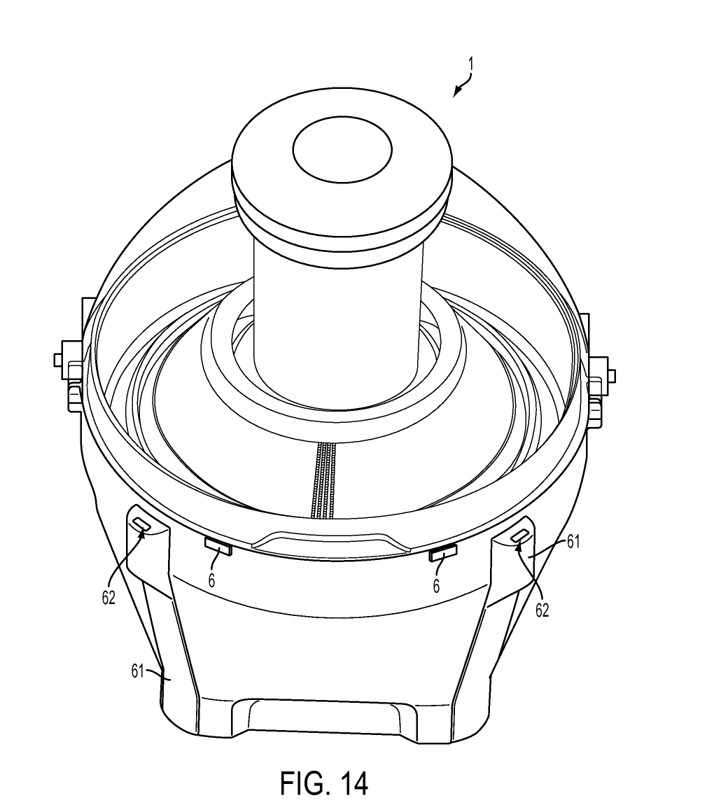

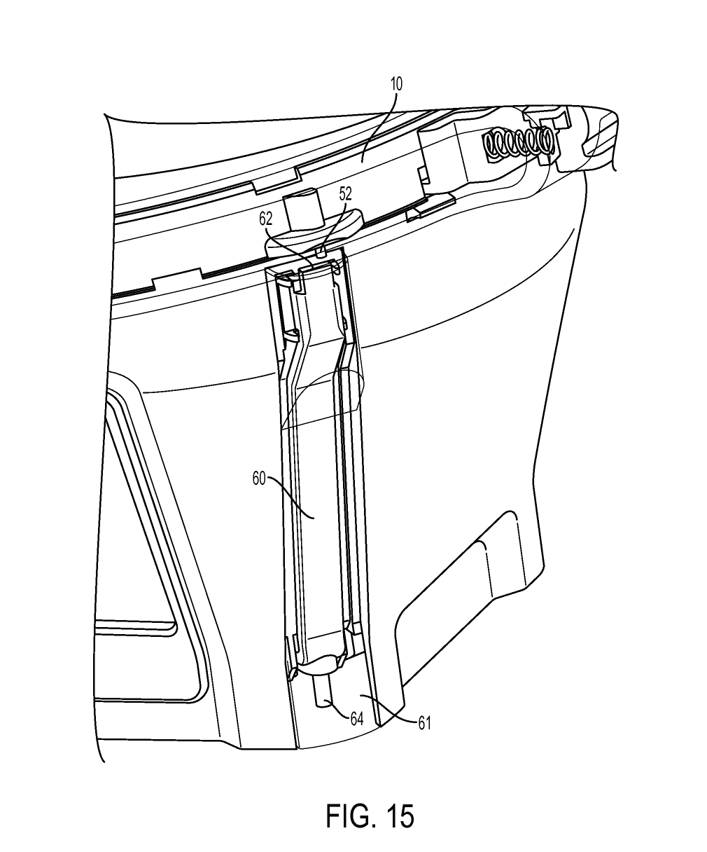

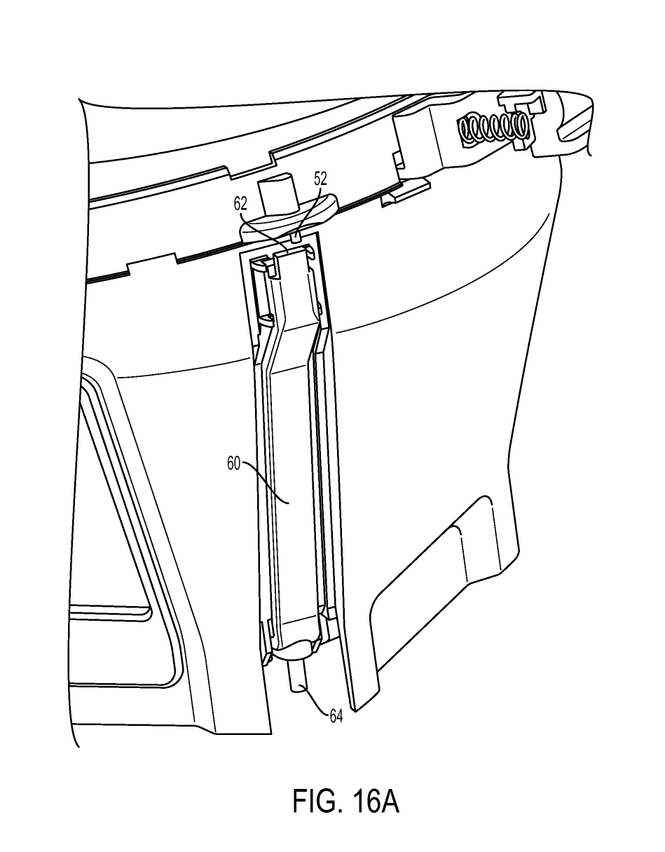

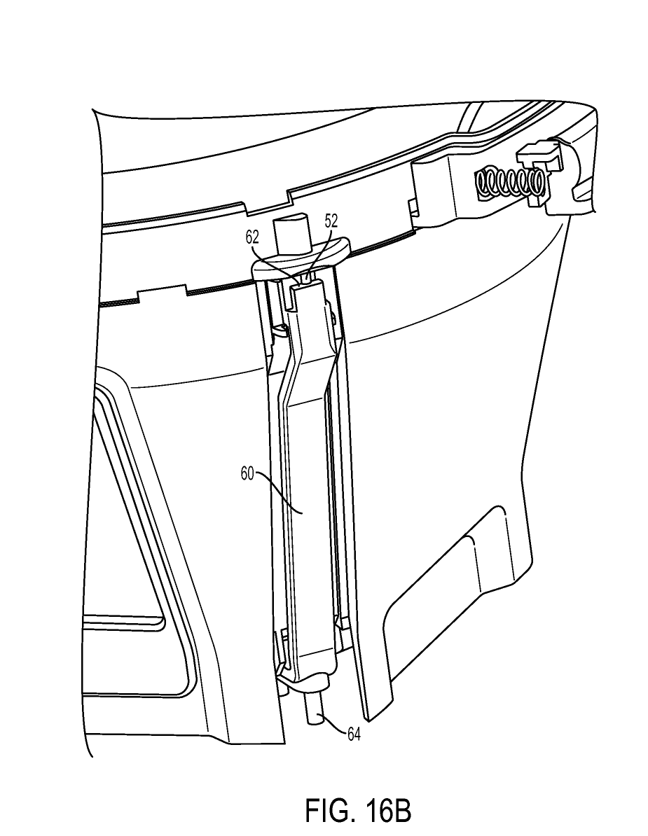

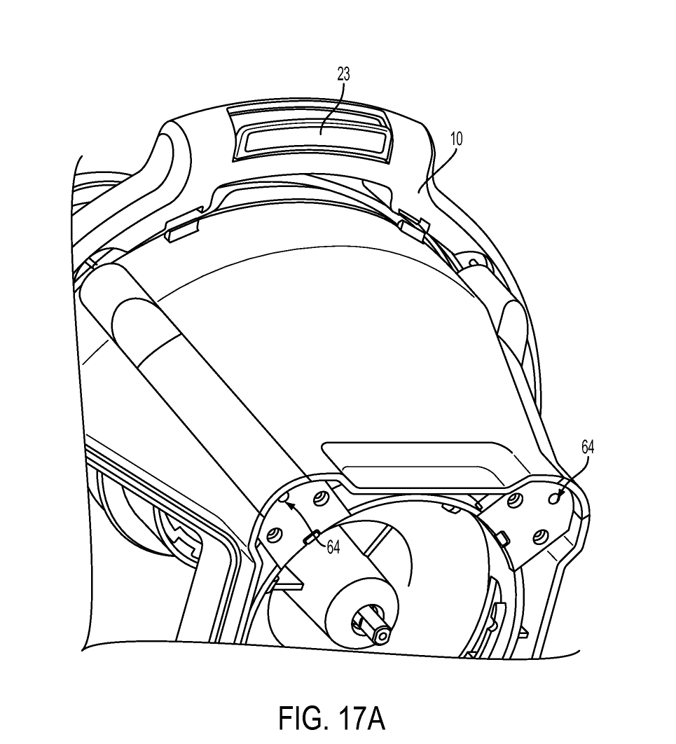

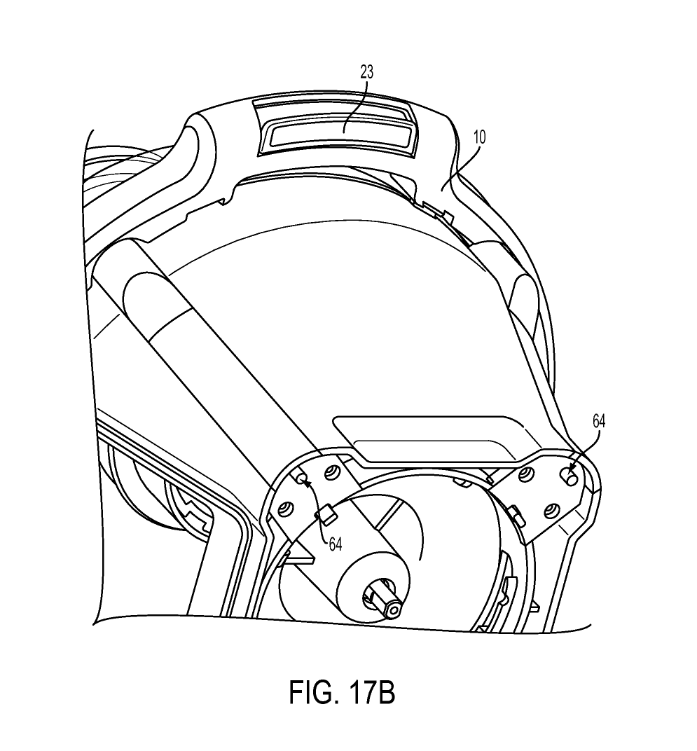

According to another aspect, the handle may function as part of a safety system which controls actuation of the motor. One embodiment of a safety system is shown in FIGS. 13-17B. As shown in FIG. 13, the underside surface of handle 10 may include pins 52. The pins 52 on the handle 10 are positioned to interact with the first ends 62 of a pair of actuators, shown in FIG. 14. In FIG. 14, actuator covers 61 obscure the rest of the actuators from view. FIG. 15 shows the actuator cover 61 in phantom, revealing the actuator 60 beneath. Actuator 60 has a first end 62 and a second end 64. When the handle 10 is rotated downward toward the actuator 60, the pins 52 on the handle 10 contact the first end 62 of the actuator 60 and causes the entire actuator 60 to shift downward. FIG. 16A shows the actuator 60 in a first position before contact with the pins 52, and FIG. 16B shows the actuator in a second, lower position after contact with the pins 52. As shown in FIGS. 17A-17B, the second end 64 of the actuator 60 also changes position as a result of contact between pins 52 and first end 62. FIG. 17A shows the second end of the actuator 64 in a first position before the actuator has contacted the pins 52, and FIG. 17B shows the second end 64 of the actuator in a second, extended position after the actuator has contacted the pins 52. The bottom of the food processing device 1 may be coupled to a base (not shown), and the base may contain a motor. Extension of the second ends 64 actuates a switch on the base, which permits activation of the motor for operation of the food processing device.

In this system embodiment, the handle 10 must be rotated down into its lowermost, locked position before the motor can be started, ensuring that the device is in a proper configuration and the handle is in a locked state before processing is permitted to begin.

In some embodiments, the food processing device itself contains a motor such that the food processing device does not couple to an additional base. In such embodiments, extension of the second ends 64 actuates a switch that permits activation of the motor for the food processing device.

The above described components may be made with various materials, as the invention is not necessarily so limited.

The above aspects may be employed in any suitable combination, as the present invention is not limited in this respect. Additionally, any or all of the above aspects may be employed in a food processing apparatus; however, the present invention is not limited in this respect, as the above aspects may be employed to devices that process materials other than food.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An apparatus comprising:
a food processing device with a first engagement member;
a handle rotatably attached to the food processing device;
a release actuator rotatably attached to the handle;
a locking member with a second engagement member that cooperates with the first engagement member, the locking member having a locked configuration where the handle is prohibited from moving relative to the food processing device due to interaction between the first and second engagement members, and an unlocked configuration where the handle is permitted to move relative to the food processing device;
wherein rotation of the release actuator relative to the handle causes linear translation of the locking member from the locked configuration to the unlocked configuration.

2. The apparatus of claim 1, wherein:
the release actuator includes a cam that rotates with the release actuator; and
the locking member includes a cam follower that cooperates with the cam.

3. The apparatus of claim 2, wherein the cam comprises a pin and the cam follower includes an opening in which the pin is positioned.

4. The apparatus of claim 2, wherein:
the release actuator rotates relative to the handle about a rotation axis; and
the rotation axis is positioned vertically above the cam when the locking member is in the locked configuration.

5. The apparatus of claim 1, wherein the handle includes a track in which the locking member moves.

6. The apparatus of claim 5, wherein the track constrains movement of the locking member such that the locking member can move along only a single axis.

7. The apparatus of claim 1, wherein:
the food processing device further comprises a motor and a motor actuator, the motor actuator being moveable between a first position and a second, extended position, wherein when the motor actuator is in the second, extended position, the motor actuator is configured to actuate a switch to permit activation of the motor; and
when the locking member is in the locked configuration, the motor actuator is in the second, extended position.

8. The apparatus of claim 7, wherein:
the food processing device further comprises a container for receiving food to be processed and a base constructed and arranged such that the container is coupleable to the base, the motor being located in the base;
when the container is coupled to the base and the motor actuator is in the second, extended position, the motor actuator is configured to actuate a switch to permit activation of the motor; and
the base is constructed and arranged such that the container can be coupled to the base when the motor actuator is in the second, extended position.

9. The apparatus of claim 2, wherein:
the release actuator includes a user engaging portion at which a user applies a force to rotate the release actuator relative to the handle about a rotation axis; and
a distance from the rotation axis to the user engaging portion is longer than a distance from the rotation axis to the cam.

10. The apparatus of claim 9, wherein the user engaging portion comprises a recess that is configured to receive a user's finger.

11. A handle arrangement for a food processing device, comprising:
a handle rotatably attachable to a food processing device, the food processing device having a first engagement member;
a release actuator rotatably attached to the handle;
a locking member with a second engagement member that cooperates with the first engagement member, the locking member having a locked configuration where the handle is prohibited from moving relative to the food processing device due to interaction between the first and second engagement members and an unlocked configuration where the handle is permitted to move relative to the food processing device;
wherein rotation of the release actuator relative to the handle causes linear translation of the locking member from the locked configuration to the unlocked configuration.

12. The apparatus of claim 11, wherein:
the release actuator includes a cam that rotates with the release actuator; and
the locking member includes a cam follower that cooperates with the cam.

13. The apparatus of claim 12, wherein the cam comprises a pin and the cam follower includes an opening in which the pin is positioned.

14. The apparatus of claim 13, wherein the handle includes a track in which the locking member moves.

15. The apparatus of claim 14, wherein the track constrains movement of the locking member such that the locking member can move along only a single axis.

16. The apparatus of claim 11, wherein:
the food processing device further comprises a motor and a motor actuator being moveable between a first position and a second, extended position, wherein when the motor actuator is in the second, extended position, the motor actuator is configured to actuate a switch to permit activation of the motor; and
when the locking member is in the locked configuration, the motor actuator is in the second, extended position.

17. The apparatus of claim 16, wherein:
the food processing device further comprises a container for receiving food to be processed and a base constructed and arranged such that the container is coupleable to the base, the motor being located in the base;
when the container is coupled to the base and the motor actuator is in the second, extended position, the motor actuator is configured to actuate a switch to permit activation of the motor; and
the base is constructed and arranged such that the container can be coupled to the base when the motor actuator is in the second, extended position.

18. A method comprising:
rotating a release actuator relative to a handle, the release actuator being rotatably attached to the handle and the handle being rotatably attached to a food processing device, wherein:
rotating the release actuator causes linear translation of a locking member from a locked configuration where the handle is prohibited from moving relative to the food processing device to an unlocked configuration where the handle is permitted to move relative to the food processing device.
